(19) United States
(12) Patent Application Publication
(10) Pub. No.: US 2015/0134288 A1
(43) Pub. Date: May 14, 2015

(54) DECOMPOSITION OF NEAR-FIELD REFLECTIONS

(71) Applicant: UTI LIMITED PARTNERSHIP, Calgary (CA)

(72) Inventors: Douglas Kurrant, Calgary (CA); Elise Fear, Calgary (CA)

(73) Assignee: UTI LIMITED PARTNERSHIP, Calgary (CA)

(21) Appl. No.: 14/286,858

(22) Filed: May 23, 2014

Related U.S. Application Data
(60) Provisional application No. 61/826,970, filed on May 23, 2013.

(51) Int. Cl. G01S 13/00; G01S 17/00; G01S 15/00

(52) U.S. Cl. CPC G01S 13/00; G01S 15/00; G01S 17/00
USPC 702/85

(57) ABSTRACT

Systems and methods for decomposition of near-field reflections are presented. In an embodiment, a method may include identifying data associated with a reference signal in a reflection-based imaging device. The method may also include identifying shifted and scaled versions of the reference signal in reflection data gathered by the reflection-based imaging device. Additionally, the method may include solving a time-of-arrival and a scaling factor of the reference signal with a non-linear optimization.

### CROSS-REFERENCE TO RELATED APPLICATIONS

This application claims the benefit of U.S. Provisional Patent Application No. 61/826,970 filed on May 23, 2013, the entire contents of which is specifically incorporated herein by reference without disclaimer.

### TECHNICAL FIELD

Embodiments of the invention are directed, in general, imaging with electromagnetic wave reflections and, more specifically, to methods and systems for decomposition of near-field reflections.

### BACKGROUND

Using Ultra-Wide Band (UWB) pulses to provide a non-invasive means of extracting properties of hidden structures is evolving into a promising technology. The basic approach is to transmit a short-duration electromagnetic wave into an object or structure of interest and then measure the backscattered fields that arise due to dielectric contrasts at interfaces. The time-of-arrival between reflections and the amplitude of the reflections may be used to infer the geometrical and dielectric properties of hidden structures or objects. For example, ground penetrating radar (GPR) has been used to determine the vertical structure of a roadway and for the characterization of snow cover in terms of depth and density of the layers.

For many of these applications, the usable spectral content of the illuminating signal is limited by the attenuation characteristics of the materials under test. In practice, there is also a limited range of frequencies over which the antenna can operate efficiently. There has evolved a class of challenging applications that require the accurate thickness estimation of thin layers, such as the thickness of a thin layer of pavement or a wall. Another possible application for near-field imaging using UWB signal pulses is estimating a breast's skin thickness for microwave radar or tomographic imaging. In these applications, the interfaces are closely separated relative to the illuminating signal's wavelength so the use of band-limited UWB signals leads to overlapping reflections.

A conventional technique used for time-delay estimation is the matched filter. The time-resolution, ΔT, is the minimum temporal separation between two reflections that this technique is able to resolve and is the inverse of bandwidth B. Therefore, the product BΔT=1 is the time-resolution limit for the matched filter which has been adopted as a benchmark to evaluate a technique's ability to resolve reflections. Improved resolution may be obtained with wider bandwidth signals.

An alternative to increasing the bandwidth of the signal, are advanced signal processing methods, such as subspace high resolution methods. For example, the thickness of thin-pavement has been estimated by applying multiple-signal classification (MUSIC), Min-norm, and estimation of signal parameters via rotational invariance techniques (ESPIRIT) to GPR data. Experimental data containing overlapping reflections backscattered from a brick wall have been resolved using polynomial versions of these algorithms.

Subspace algorithms are based on the Eigen structure properties of the correlation matrix estimated as an ensemble average of the received data. This matrix is used to distinguish between signal and noise subspaces to perform the time-delay estimation. However, the averaging techniques used to estimate the correlation matrix typically require many data records that are not always available in a practical scenario. Furthermore, special preprocessing steps may be performed on the data so that the structure and assumptions imposed by these methods are not violated (e.g., signal subspace is orthogonal to the noise subspace). For example, the input data requires whitening and the sensitivity of these algorithms to the correlation magnitude between reflections demands spatial smoothing.

### SUMMARY

Systems and methods for decomposition of near-field reflections are presented. In an embodiment, a method may include identifying data associated with a reference signal in a reflection-based imaging device. The method may also include identifying shifted and scaled versions of the reference signal in reflection data gathered by the reflection-based imaging device. Additionally, the method may include solving a time-of-arrival and a scaling factor of the reference signal with a non-linear optimization.

In an embodiment, a system may include an imaging signal source configured to generate a signal to be directed to a reference object and a test object. Additionally, the system may include a reflection detector configured to receive one or more reflections of the signal from the reference object and the test object. The system may also include a data processor coupled to the reflection detector. In one embodiment, the data processor may be configured to identify data associated with a reference signal in a reflection-based imaging device, identify shifted and scaled versions of the reference signal in reflection data gathered by the reflection-based imaging device, and solve a time-of-arrival and a scaling factor of the reference signal with a non-linear optimization.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating one embodiment of a system for determining a reference signal for implementing one embodiment of a method for decomposition of near-field reflections.

FIG. 2 is a schematic flowchart diagram illustrating one embodiment of a method for decomposition of near-field reflections.

FIG. 3 is a schematic flowchart diagram illustrating one embodiment of a method for decomposition of near-field reflections.

FIG. 4 is a schematic block diagram illustrating one embodiment of a data processing device configurable to perform operations for decomposition of near-field reflections.

FIG. 5 shows the relative error of the thickness estimates of the first layer of FIG. 1 versus BΔT.

FIG. 6 illustrates the effect that noise level has on parameter estimation algorithm when estimating TOA of a weak 3^{rd} reflection.

FIG. 7 illustrates a model of a three layer slab and sensor used to evaluate the algorithm's performance when applied to 3D numerical data.

FIG. 8A illustrates data representing a reflection according to the present embodiments.

FIG. 8B illustrates data representing a reflection according to the present embodiments.

FIG. 8C illustrates data representing a reflection according to the present embodiments.

FIG. 9A. illustrates test data acquired from dielectric slab covered by thin skin layer and metal plate reference signal.

FIG. 9B. illustrates test data acquired from dielectric slab covered by thin skin layer and metal plate reference signal.

FIG. 10A. illustrates test data acquired from three layered dielectric slab and metal plate reference signal.

FIG. 10B. illustrates test data acquired from three layered dielectric slab and metal plate reference signal.

### DETAILED DESCRIPTION

The present embodiments may eliminate pre-processing steps by adapting an iterative technique to provide a simple approach to resolve overlapping reflections that may occur in near-field applications. Super-resolution is achieved by taking the iterative approach to solve a highly non-linear problem. The present embodiments may have broader applicability in estimation of layer thickness in structures consisting of multiple layers.

In one embodiment, a short-duration electromagnetic wave may be transmitted into an object or structure of interest and the backscattered fields that arise due to dielectric contrasts at interfaces may be measured. The total signal is decomposed into reflections originating from each of the interfaces of interest. The time-of-arrival (TOA) between reflections and the amplitude of the reflections may be used to infer the geometrical and dielectric properties of hidden structures or objects. For electrically thin layers, the limited bandwidth of the illuminating signal typically gives rise to overlapping reflections. The present embodiments describe an iterative nonlinear parameter estimation technique that may be used for near-field applications. The effectiveness of the algorithm to decompose the reflection data has been evaluated using numerical data generated from 2D and 3D dielectric slabs, multilayer cylindrical objects with cylindrical inclusions, and realistic breast phantoms with glandular inclusions and experimental data from multi-layered slabs and multilayered cylindrical objects with cylindrical inclusions. The results confirm that the present embodiments offer advantages over prior techniques.

For discussion purposes, the present embodiments may be described in the context of a test setup 100 having a dielectric slab consisting of multiple homogeneous layers and placed in a region with known dielectric properties. A sensor 104 and source 102 may be co-located near an object 106 the thin outer layer 108 and layer 110 is sandwiched between 108 and 112. The source 102 illuminates the object 106 with a pulse of electromagnetic (EM) or acoustic energy, and the sensor 104 records the resulting backscattered fields. In an embodiment, the sensor 104 and the source 102 may be integrated into a single antenna with attached transmitter and receiver components, including filters for separating transmitted signals from received signals.

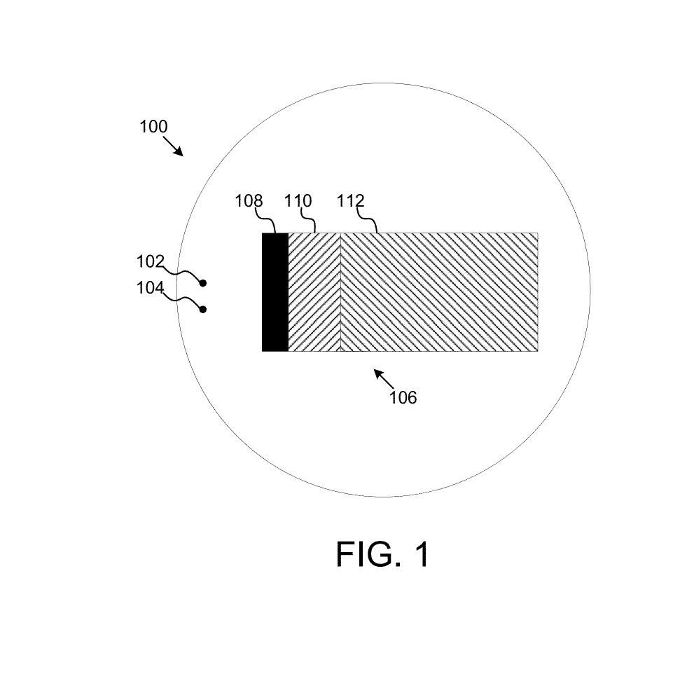

Although the embodiment of FIG. 1 illustrates a planar object 106 having a generally rectangular shape, one of ordinary skill will recognize that the present embodiments may be used for imaging of objects of various shapes and contours. Indeed, many objects 106 may have irregular shapes. For example, objects 106 may have curved surfaces. Objects 106 may be generally cylindrical or spherical for example. In some bio-medical applications, an object 106 such as a tumor may have a very irregular shape. In other applications, such as ground-penetrating radar applications, the object may be interfaces between soil or rock layers, oil layers, water layers, etc, and may be generally planar. In other embodiments, such as applications for archeology, the objects 106 may be various man-made shapes. Further examples of various shapes of objects 106 that may be imaged according to the present embodiments are described in Kurrant, D. et al., “Defining Regions of Interest for Microwave Imaging Using Near-Field Reflection Data,” IEEE Transactions on Microwave Theory and Techniques, Vol. 61, No. 5 (May 2013), which is incorporated herein by reference in its entirety.

An embodiment of a method described herein may estimate the amplitude and Time of Arrival (TOA) of the reflection that arises from each boundary of layers 108-112. In this example, it can be assumed that each layer's relative permittivity, or other relative properties such as density, may be estimated, but one of ordinary skill will recognize that this is merely a simplification for discussion purposes, and that the present embodiments may be expanded beyond the scope of the described examples. With a layer's permittivity known, the TOA evaluated from each reflection may be used to estimate the layer thickness; however, other estimation techniques may be used in combination with the present embodiments.

Data received by the sensor 104 may be conditioned to remove the transmitted signal from the reflection data. In an embodiment, the pre-conditioned data y(t) may be modeled as a superposition of M scaled and delayed replicas of a reference signal r(t) plus noise:

$$y ( t ) = {\sum }_{m = 1}^{M} {α}_{m} r ( t - {τ}_{m} ) + e ( t ) , 0 \leq t \leq T \qquad ( 1 )$$

where M is the number of replicas of r(t); αₘ and τₘ are the scaling factor and TOA of the m^{th} replica, respectively; and e(t) is noise modeled as a zero-mean Gaussian random process (GPR). In one embodiment, far-field conditions (i.e., the Fraunhoffer limit) may apply to GPR applications, so the backscattered reflections may be assumed to be time-shifted copies of the transmitted signal that are reflected from the medium interfaces. Near-field conditions may render this assumption invalid. Therefore, a reference signal selected to adapt to the physical behavior exhibited for near-field applications may be used according to the present embodiments. In one embodiment, the reference signal r(t) and the scaling factors are real valued. Uniform sampling of y(t) at rate Tₛ may lead to the discrete version of Eq. (1)

$$y ( {nT}_{s} ) = {\sum }_{m = 1}^{M} {α}_{m} r ( {nT}_{s} - {τ}_{m} ) + e ( {nT}_{s} ) , n = 0 , … , N - 1 \qquad ( 2 )$$

where N is the number of samples.

The discrete Fourier Transforms (DFTs) of y(nTₛ), r(nTₛ), and e(nTₛ) are Y(k), R(k), and E(k), respectively where k=−N/2, . . . , N/2−1. Provided that aliasing is negligible, the spectrum of the received data Y(k) is modeled as

$$\begin{matrix}\begin{matrix}Y ( k ) = {\sum }_{m = 1}^{M} R ( k ) {α}_{m} {e}^{j {w}_{m} k} + E ( k ) \\ = {Y}^{s} ( k ) + E ( k ) ,\end{matrix} & ( 3 ) \\ k = - N / 2 , … , N / 2 - 1 & \end{matrix}$$

where wₘ=−2π(τₘ)/NTₛ and Y^{s}(k) is the spectrum of the signal model. The spectrum of the signal model is written more compactly as

$${Y}^{s} = {\sum }_{m = 1}^{M} {α}_{m} {RW}_{m} \qquad ( 4 )$$

where Y^{s}=[Y^{s}(−N/2) . . . Y^{s}(N/2−1)]^{T}, R=diag{R(−N/2) . . . R(N/2−1)}, and Wₘ=[e^{jw}^{_{m(−N/2)}} . . . e^{jw}^{_{m(n/2−1)}}]^{T}.

Estimates {\hat{α}ₘ,ŵₘ}ₘ₋₁^{M} are obtained from the spectrum by minimizing the nonlinear least-squares criterion

F₁({\hat{α}ₘ,ŵₘ}ₘ₌₁^{M)}=∥Y−Y^{s}∥² (5)

In an embodiment, the spectrum associated with the i^{th} reflection is extracted from Y using

$${Y}_{i} = Y - {\sum }_{m = 1 , m \neq i}^{M} {\hat{α}}_{m} R {\hat{W}}_{m} . \qquad ( 6 )$$

where {\hat{α}ₘ, ŵₘ}_{m=1,m≠i}^{M} are given. This leads to the following optimization problem

F₂(αᵢ,wᵢ)=∥Yᵢ−αᵢRWᵢ∥ (7)

The decoupled parameter estimation method decouples the estimation of the parameters by successively solving two 1D optimization problems. First wᵢ is estimated using

$${\hat{w}}_{i} = arg {max}_{{τ}_{i}} {Re [ IDFT ( {R}^{H} {Y}_{i} ) ]}^{2} \qquad ( 8 )$$

where (•)^{H} is the conjugate transpose. In an embodiment, the time-of-arrival parameter may be obtained from the spectral component, ŵᵢ, of the dominant peak of the spectrum with \hat{τ}ᵢ=ŵᵢNTₛ/(2π). When calculating the Fourier transforms R and Y, the data r and y may be zero-padded to extend the duration T of each signal as a means of interpolating the spectrum between Fourier coefficients to improve the accuracy of \hat{τ}ᵢ. In one embodiment, \hat{τ}ᵢ is an integer multiple of T_{S} which may lead to error in this estimate. The accuracy of \hat{τ}ᵢ can be further improved by allowing this estimate to assume fractional multiples of T_{S}. Specifically, piecewise cubic interpolation may be performed within a closed interval of data that contains this value. The density of data contained in this interval and the order of DFT used to calculate R and Y are factors that contribute to the accuracy of \hat{τ}ᵢ. Once \hat{τ}ᵢ is evaluated, a method for bracketing the minimum such that αᵢ∈[α_{L}, α^{H}] may be performed. Next, given \hat{τ}ᵢ, this estimate is used to calculate ŵᵢ=−2π(\hat{τ}ᵢ)NTₛ and a golden section technique is used to minimize

F₃(αᵢ)=∥Y−Yₛ∥²|wᵢ=Ŵᵢ,αᵢ∈[α_{L},α_{H}]. (9)

In one embodiment, when e(nTₛ) is a zero-mean white Gaussian random process, E(k) is also white since the DFT is a unitary transformation. Furthermore, by assuming this noise model, the nonlinear least-squares estimation technique is equivalent to the maximum likelihood (ML) method so it is asymptotically efficient. However, this equivalence is invalid when the noise model assumptions no longer hold.

In one embodiment, these methods may be used to estimate the set of model parameters {\hat{α}ₘ,ŵₘ}ₘ₌₁^{M} as follows:

Step 1: Set M=1 and use (8) and (9) to evaluate {\hat{α}ₘ, ŵₘ}ₘ₌₁ from Y.

Step 2.1: Set M=2. Given {\hat{α}ₘ, ŵₘ}ₘ₌₁ found in step 1, use (6) to compute Y₂. Use (8) and (9) to evaluate {\hat{α}ₘ, ŵₘ}ₘ₌₂ from Y₂.

Step 2.2: Given {\hat{α}ₘ, ŵₘ}ₘ₌₂ found in step 2.1, use (6) to compute Y₁. Refine the estimates {\hat{α}ₘ, ŵₘ}ₘ₌₁ from Y₁ using (8) and (9).

Step 2.3: Iterate steps 2.1-2.2 until convergence is implied such as when: ∥F₁₍ₚᵣₑᵥᵢₒᵤₛ₎−F₁₍ₚᵣₑₛₑₙₜ₎∥/∥F₁₍ₚᵣₑᵥᵢₒᵤₛ₎∥<δ.

Step 3.1: Set M=3. Given {\hat{α}ₘ,ŵₘ}ₘ₌₁² found in step 2, use (6) to compute Y₃. Evaluate {\hat{α}ₘ,ŵₘ}ₘ₌₃ from Y₃ using (8) and (9).

Step 3.2: Given {\hat{α}ₘ,ŵₘ}ₘ₌₂³, use (6) to compute Y₁. Refine the estimates {\hat{α}ₘ, ŵₘ}ₘ₌₁ from Y₁ using (8) and (9).

Step 3.3: Given {\hat{α}ₘ,ŵₘ}_{m=1,3}, use (6) to compute Y₂. Refine the estimates {\hat{α}ₘ,ŵₘ}ₘ₌₂ from Y₂ using (8) and (9).

Step 3.4: Iterate steps 3.1-3.3 until convergence is implied.

In one embodiment, this method may continue in a similar manner until M is equal to the desired or estimated model order.

This technique may be referred to as a “reflection data decomposition algorithm.” The technique is applied to the recorded reflection signal and decomposes the signal into M components by estimating the TOA and scaling factor of the reflection that arises from each interface.

The TOA estimate associated with successive reflections is used to compute the thickness of the i^{th} layer, ŵ(i). The i^{th} layer thickness is estimated assuming an average relative permittivity for the i^{th} layer.

The cost function given by Eq. (5) may have many false local minima. In one embodiment, convergence to a global minimum is facilitated by the specific sequence of steps taken by the algorithm. In particular, the algorithm's use of the spectrum and the corrected spectrum (i.e., the spectrum of the Yᵢ's in Eq. (6)) encourages the initialization of each search step with reasonable estimates of {αₘ, wₘ}.

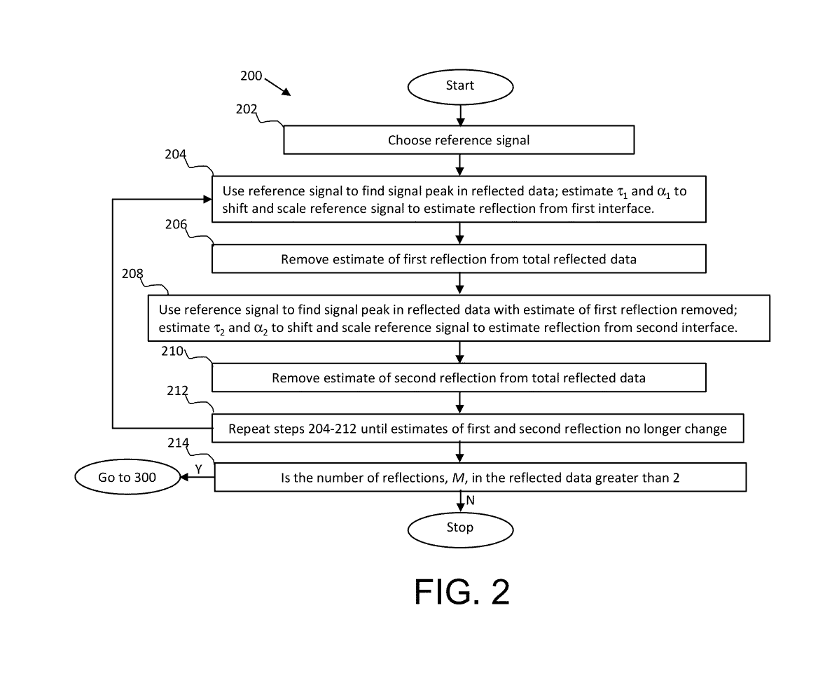

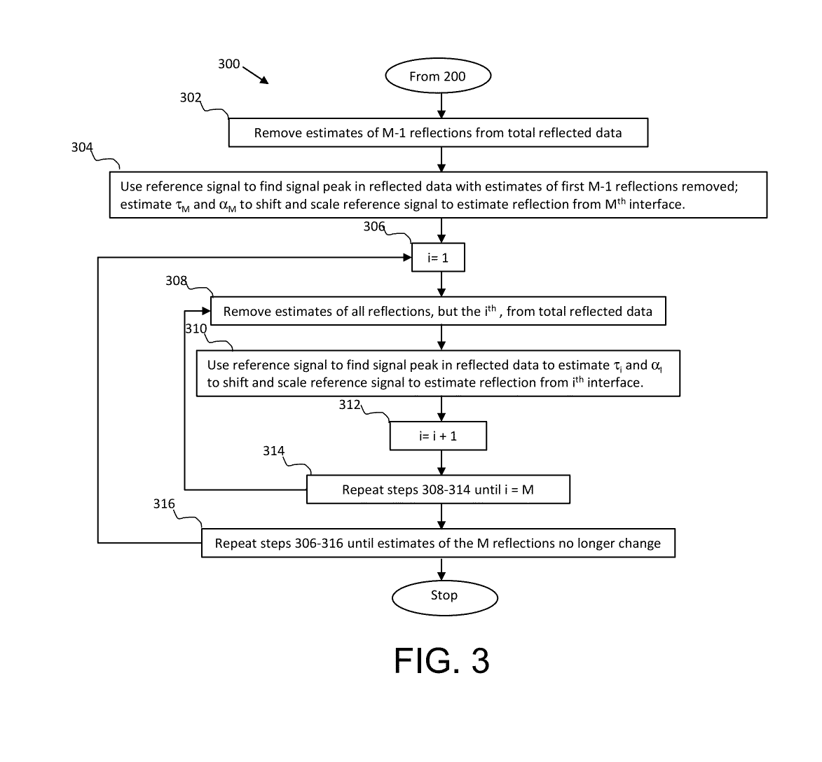

FIGS. 2-3 illustrate embodiments of program instructions which may be used to implement embodiments of methods according to the present embodiments. At block 202, the method 200 includes choosing a reference signal from a group of received reflection signals. A first iterative look is described in block 204, where the reference signal is used to find the dominant peak in the spectrum of the reflected data in order to estimate the time-of-arrival and scaling factor of the dominant reflection. Since the reference signal is used to model reflections, the scaled and time-shifted version of the reference is used to estimate the reflection off the first interface. At block 206 the estimate of the first reflection is removed from the total reflected data. At block 208 the reference signal is used to find the dominant peak in the spectrum of the residual reflected data (i.e., total reflected data with the estimate of the first reflection removed) in order to estimate the time-of-arrival and scaling factor of the reflection from the second interface. The estimate of the second reflection is then removed from the total reflected data at block 210. At block 212, the loop continues to iteratively refine the estimates by using the spectrum of the residual reflected data and the corrected spectrum of the first two reflections until there is no change in the values of the estimates. If there are only two reflections contained in the data, then the procedure terminates at block 214. Otherwise, the iterative procedure continues to block 302 to extract the estimate of the reflection from the M^{th} interface contained in the reflected data.

As shown in FIG. 3, a first iterative look is described in block 302, whereby estimates of the first M−1 reflections are removed from the total reflected data. At block 304, the reference signal is used to find the dominant peak in the spectrum of the residual reflected data to estimate the M^{th} reflection. A counter is initialized by setting i=1 at block 306. At block 308, all modeled reflections, other than the i^{th}, are removed from the total reflected data. The reference signal is used to find the dominant peak in the spectrum of the residual reflected data to refine the estimate of the time-of-arrival and scaling factor of the reflection from the i^{th} interface at block 310. The counter is incremented so that i=i+1 at block 312. At block 314, the reference signal is used to find the dominant peak in the spectrum of the residual reflected data to refine the estimate of the time-of-arrival and scaling factor of the reflection from the second interface. At block 314, the loop continues until the estimates of all M reflections have been refined. At block 316, the loop continues until there is no change in the values of the estimates. The procedure terminates at block 316 so that the total reflection data are decomposed into M reflections.

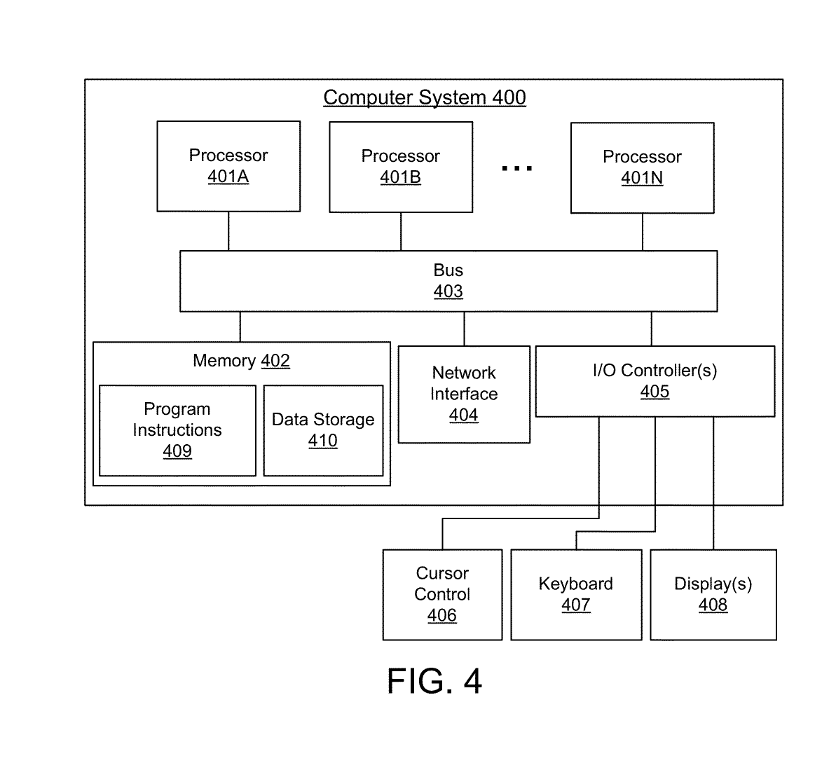

FIG. 4 is a schematic block diagram illustrating one embodiment of a computer system 400 configurable for decomposition of near-field reflections. In one embodiment, the methods described above may be implemented on a computer similar to the computer system 400 described in FIG. 4. In various embodiments, computer system 400 may be a server, a mainframe computer system, a workstation, a network computer, a desktop computer, a laptop, or the like.

As illustrated, computer system 400 includes one or more processors 401A-N coupled to a system memory 402 via bus 401. Computer system 400 further includes network interface 404 coupled to bus 401, and input/output (I/O) controller(s) 405, coupled to devices such as cursor control device 406, keyboard 407, and display(s) 408.

In various embodiments, computer system 400 may be a single-processor system including one processor 401A, or a multi-processor system including two or more processors 401A-N (e.g., two, four, eight, or another suitable number). Processor(s) 401A-N may be any processor capable of executing program instructions. For example, in various embodiments, processor(s) 401A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 401A-N may commonly, but not necessarily, implement the same ISA. Also, in some embodiments, at least one processor(s) 401A-N may be a graphics processing unit (GPU) or other dedicated graphics-rendering device.

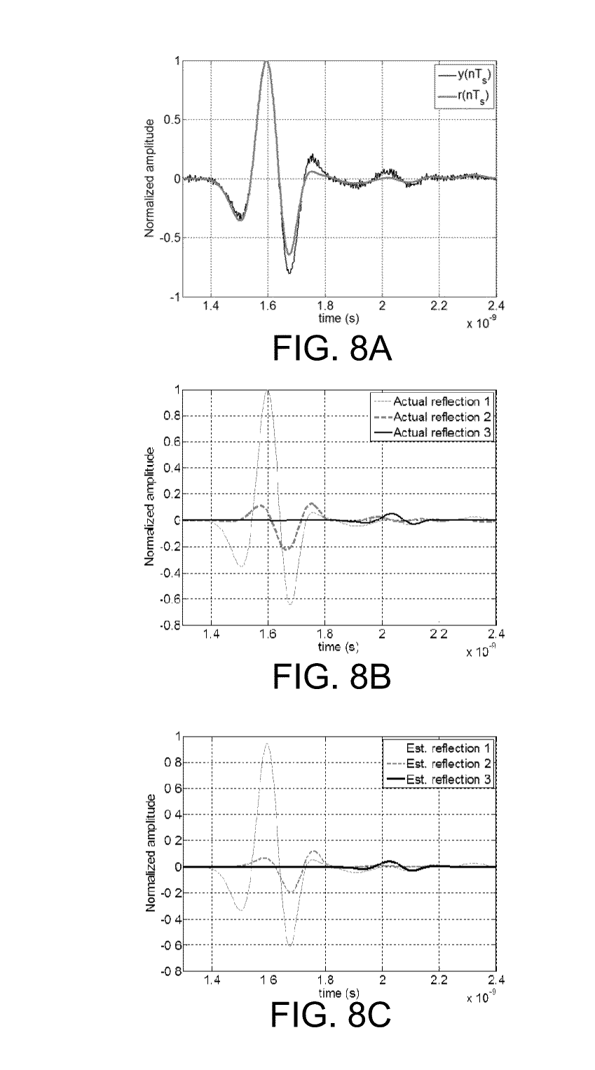

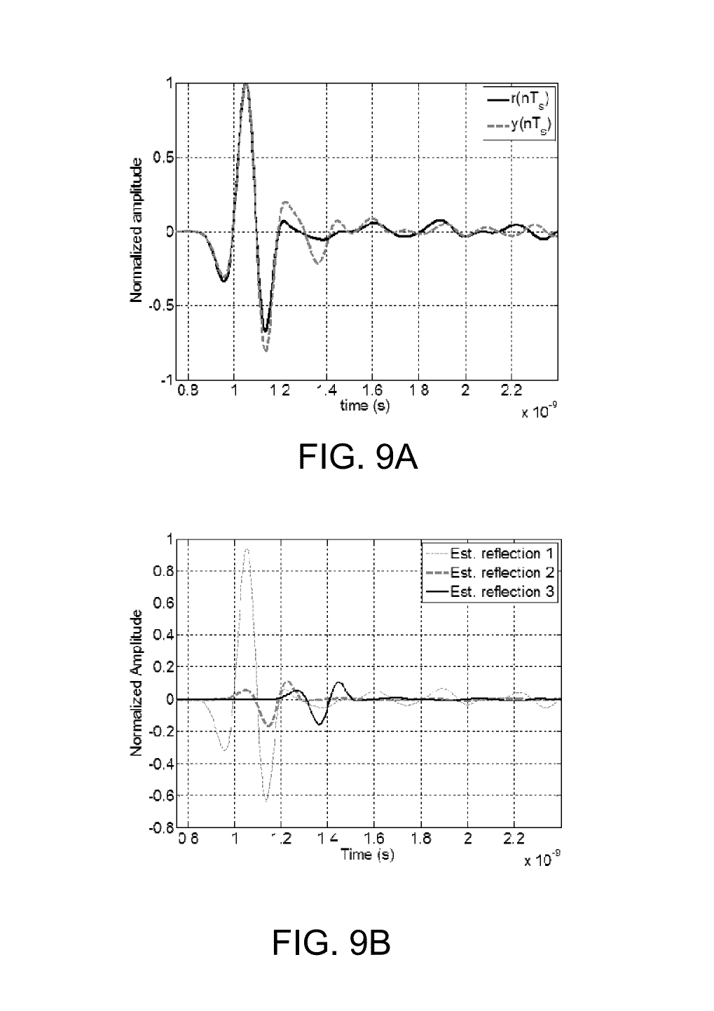

System memory 402 may be configured to store program instructions and/or data accessible by processor(s) 401A-N. For example, memory 402 may be used to store software program and/or database shown in FIGS. 8-9. In various embodiments, system memory 402 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 402 as program instructions 401 and data storage 405, respectively. In other embodiments, program instructions and/or data may be received, sent or stored upon different types of computer-accessible media or on similar media separate from system memory 402 or computer system 400. Generally speaking, a computer-accessible medium may include any tangible, non-transitory storage media or memory media such as electronic, magnetic, or optical media—e.g., disk or CD/DVD-ROM coupled to computer system 400 via bus 401, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 401 may be configured to coordinate I/O traffic between processor 401, system memory 402, and any peripheral devices including network interface 404 or other peripheral interfaces, connected via I/O controller(s)405. In some embodiments, bus 401 may perform any necessary protocol, timing or other data transformations to convert data signals from one component (e.g., system memory 402) into a format suitable for use by another component (e.g., processor(s) 401A-N). In some embodiments, bus 403 may include support for devices attached through various types of peripheral buses, such as a variant of the Peripheral Component Interconnect (PCI) bus standard or the Universal Serial Bus (USB) standard, for example. In some embodiments, the operations of bus 403 may be split into two or more separate components, such as a north bridge and a south bridge, for example. In addition, in some embodiments some or all of the operations of bus 403, such as an interface to system memory 402, may be incorporated directly into processor(s) 401A-N.

Network interface 404 may be configured to allow data to be exchanged between computer system 400 and other devices, such as other computer systems attached to the computer system 400 including an antenna, transducer, signal generators, signal filters, analog to digital converters, digital to analog converters, for example. In various embodiments, network interface 404 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 405 may, in some embodiments, enable connection to one or more display terminals, keyboards, keypads, touch screens, scanning devices, voice or optical recognition devices, or any other devices suitable for entering or retrieving data by one or more computer system 400. Multiple input/output devices may be present in computer system 400 or may be distributed on various nodes of computer system 400. In some embodiments, similar I/O devices may be separate from computer system 400 and may interact with computer system 400 through a wired or wireless connection, such as over network interface 404.

As shown in FIG. 4, memory 402 may include program instructions 409, configured to implement certain embodiments described herein, and data storage 405, comprising various data accessible by program instructions 409. In an embodiment, program instructions 409 may include software elements of embodiments illustrated in FIGS. 8-9. For example, program instructions 409 may be implemented in various embodiments using any desired programming language, scripting language, or combination of programming languages and/or scripting languages. Data storage 405 may include data that may be used in these embodiments. In other embodiments, other or different software elements and data may be included.

A person of ordinary skill in the art will appreciate that computer system 400 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

### Examples

### Generation of Numerical Data

Numerical simulations with the finite difference time domain (FDTD) method may be used to generate test data. In these examples, the FDTD problem space is bounded by a five-cell thick perfectly matched layer (PML) boundary (4th order, the reflection coefficient of the PML medium at normal incidence is R(0)=10⁻⁷), and consists of 220×280 cells with spatial grid resolution of 0.5 mm.

In an embodiment, a stratified and non-dispersive dielectric slab may be placed within the problem space such that the sensor and source are co-located 10 mm from the slab's surface. Both the slab and source/sensor are located in free space. An impressed current source is used in these TM_{z} simulations. The number of samples is N=4000, and the sample time is Tₛ=1.06 ps.

The slab may be illuminated with an UWB differentiated Gaussian pulse. The maximum frequency fₘₐₓ of the pulse is defined as the frequency at which the magnitude of the spectrum is 10% of the maximum.

The modeled data may be contaminated with white Gaussian noise samples e(nTₛ). The noise level in the signal (i.e., the variance σ₂) is adjusted so that the signal-to-noise ratio (SNR) is 20, 10, or 0 dB, where each SNR is defined as the ratio of the signal power to the total power of the noise process.

The reference signal, r(nTₛ), may be constructed by scaling and time-shifting a reflection from a dielectric slab. The scaling is adjusted so the positive maxima of the reference signal and the received reflection data are equivalent. The resulting signal is then time-shifted so the positive maxima of the reference signal and the reflection data coincide. This allows the decomposition algorithm to adapt to near-field applications where uniform plane wave assumptions do not hold. That is, the reference signal used implicitly takes into account subtle near-field effects that occur and may introduce artifacts to the decomposition results.

Assessing the Performance of the Algorithm

To assess the performance of the decomposition algorithm, the reflection from each of the three interfaces, as illustrated in FIG. 1, is isolated in order to extract reference values for the scaling factors and TOAs. In case 1, a simulation is carried out with a homogeneous slab (i.e. entire slab has the same properties as the outer skin layer) to obtain an isolated version of the reflection from the first interface. The reflection that is acquired is normalized by the positive maximum of the reflection, then characterized by the scaling factor, α₁=1.0, and τ₁ which is the time that the positive maximum occurs. In case 2, a simulation is carried out with the third layer replaced with a dielectric material with the same properties as the second layer. To isolate the reflection from the second interface, the reflection from the first interface (case 1) is subtracted. The remaining signal is then normalized to the case 1 reflection. Case 3 consists of the multilayered slab under test. Cases 1 and 2 reflections are subtracted from the resulting data, isolating the reflection from the third interface. After normalizing to the case 1 reflection, the resulting signal is characterized by the scaling factor α₃ and τ₃.

The scaling factor error αₑ(i) for the i^{th} reflection is calculated by computing the error relative to the actual scaling factor using

$${α}_{e} ( i ) = \frac{( \hat{α} ( i ) - α ( i ) )}{\vert α ( i ) \vert} for i = 1 , 2 , 3 \qquad ( 11 )$$

where \hat{α}(i) is the algorithm's estimate of the i^{th} scaling factor. The TOA error, Δτₑ(i), for i^{th} reflection is calculated by subtracting the actual TOA of the reflection from the estimated TOA of the reflection. Rather than examining the TOA error directly, the spatial error, Δwₑ(i), for the i^{th} layer is of greater practical interest and is calculated using

$$Δ {w}_{e} ( i ) = \frac{( Δ {τ}_{e} ( i ) ) {c}_{0} ( {T}_{s} ) {10}^{3}}{2 ( {T}_{s} ) \sqrt{{ɛ}_{ri}}} ( mm ) for i = 1 , 2 \qquad ( 12 )$$

where ∈ᵣᵢ is the average relative permittivity of the i^{th} layer and cₒ is the speed of light in free space.

Results

The reflection data decomposition algorithm is applied to the recorded reflection data to test the ability of the algorithm to resolve two overlapping reflections and to identify weaker reflections. For all cases, the convergence criterion shown in step 2.3 in is set to δ=1 e-4.

Resolving Two Reflections

A three layer slab illustrated in FIG. 1 may be used to evaluate the ability of the algorithm to resolve two overlapping reflections. The thickness and conductivity of the first layer are fixed at 1 mm and σ₁=4.0 S/m, respectively; the middle layer is 12 mm thick with ∈ᵣ₂=9.0, σ₂=0.4 S/m; and the third layer is 57 mm thick with ∈ᵣ₃=40.0, σ₃=4.0 S/m. The slab is illuminated with an UWB differentiated Gaussian pulse having a −3 dB bandwidth of 8.19 GHz (2.83-11.02 GHz) so 1/B 115 Ts. The maximum frequency (fₘₐₓ) of the pulse is 15.19 GHz. The overlap between the first and second reflection is progressively increased by reducing the relative permittivity of the first layer so that ∈ᵣ₁=[36, 28, 24, 18, 16]. Since the time resolution limit of the matched filter (BΔT=1) is used as a benchmark, the overlap relative to this benchmark is BΔT={0.33, 0.29, 0.27, 0.23, 0.21}.

TABLE I
Parameter estimation of the three reflections for increasing overlap
between the 1st two reflections when the data are contaminated with
white Gaussian noise (SNR = 20 dB).

| | Δwₑ(1) | Δwₑ(2) | | | |
|---|---|---|---|---|---|
| | (mm) | (mm) | αₑ(1) | αₑ(2) | αₑ(3) |
| BΔT | (%) | (%) | (%) | (%) | (%) |
| 0.33 | 0.05 | −0.05 | 0.0 | −4.3 | 0.9 |
| | (5%) | (0.4%) | | | |
| 0.29 | 0.12 | −0.16 | 0.0 | 6.6 | 2.2 |
| | (12%) | (1.3%) | | | |
| 0.27 | 0.16 | −0.27 | 0.0 | 13.7 | 5.6 |
| | (16%) | (2.3%) | | | |
| 0.23 | 0.34 | −0.32 | 0.0 | 28.0 | −0.5 |
| | (34%) | (−2.7%) | | | |
| 0.21 | 0.38 | −0.42 | 0.0 | 34.4 | +1.8 |
| | (38%) | (−3.5%) | | | |

For these examples, the reference signal used by the algorithm is constructed by scaling and time-shifting a reflection from a dielectric slab with ∈ᵣ₁=36.0, σ₁=4.0 S/m. The reflection data are decomposed into M=6 components by estimating the TOA and scaling factor of the reflection that arises from each interface.

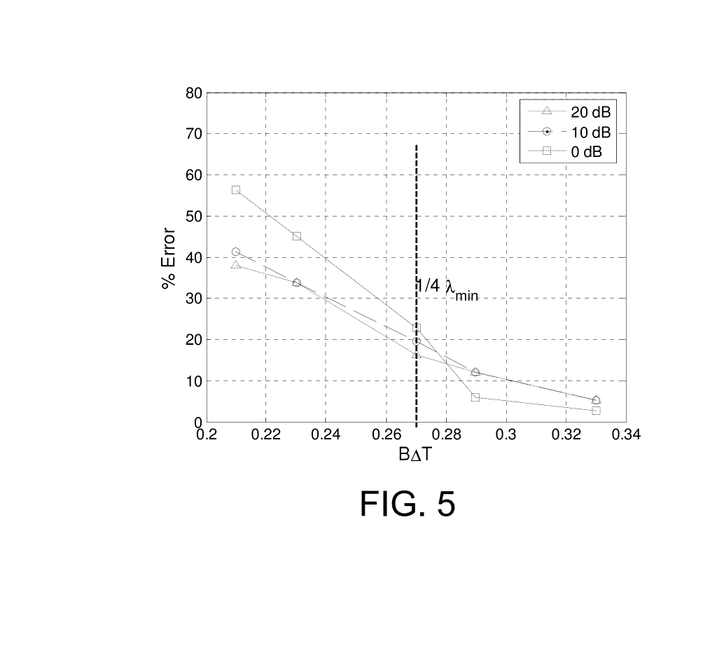

Results are shown in Table I. First, for the baseline case where BΔT=0.33, the reflection parameters are estimated very accurately in spite of the significant overlap between the first two reflections. The trend continues for BΔT=0.27; however a further increase in the overlap leads to the deterioration of the parameters associated with the 2^{nd} reflection. This trend is demonstrated more clearly in FIG. 5, which also shows the impact that the noise level has on the relative error of the layer 1 thickness. The layer thickness is estimated accurately at low SNRs even for a response overlap of BΔT=0.27.

More specifically, FIG. 2. shows the relative error of the 1^{st} layer thickness versus BΔT. The reflection data are contaminated with WGN independent and identically distributed noise samples drawn from a Gaussian distribution so the graph shows the effect that both the noise level and the reflection overlap have on the quality of the estimates. The physical resolution of the illuminating signal is about one-quarter of the wavelength of the illuminating signal (or one-quarter of the shortest wavelength that makes up the illuminating signal that is transmitted through the object under test if a pulse is used) 0.25λₘᵢₙ which is shown as the dashed vertical line.

In one embodiment, the resolution is physically controlled by the wavelength, the contrast in electromagnetic properties, and the size, shape and orientation of the target. As a rough guide, the contrast in permittivity may occur within a distance of one-quarter of a wavelength, i.e., 0.25λₘᵢₙ, where λₘᵢₙ is the shortest wavelength transmitted through the material. This value may be referred to as the approximate physical limit of the illuminating signal which is identified in FIG. 5 and observe that this limit coincides with a reflection separation of BΔT=0.27. However, regardless of the high degree of overlap that occurs when the BΔT product is less than 0.27, the first layer thickness is still estimated with sub-mm precision.

Finally, in one embodiment, a reference signal may be used that is generated with an object that has differences from the object under test. This is demonstrated by the results shown in Table I and FIG. 5. These results are obtained using a reference signal for which a significant discrepancy (up to 44%) exists between the dielectric properties of the slab used to construct the reference signal and the dielectric properties of the first two layers. This demonstrates that the waveform shape of the reference is robust to discrepancies between the material properties for which the reference signal is acquired and the dielectric properties of the interface from which a target reflection arises. This is an important result since it exemplifies that model assumptions, namely the preservation of the waveform shape, are not violated when the reflection signal and the material properties of the interface are both unknown. Furthermore, the results demonstrate that the algorithm is robust to the presence of noise at low signal-to-noise levels.

In one embodiment, the medium is non-dispersive. Distortion of the waveform shape due to dispersion can lead to violation of the model assumptions given in (1) and consequent degradation of the estimator's performance. The degree that the shape is distorted is likely to be influenced by the dispersive properties of the medium, the extent of the layer, and the BW of the incident pulse. For thin layers, the shapes of the waveforms are not expected to vary over regions that are sub-wavelengths in extent.

Estimating the Parameters for Weak Reflections

In an embodiment, the method may identify a weaker reflection among stronger ones. This capability is of interest in practical scenarios where it is necessary to detect a weak third reflection that arises from a low contrast interface embedded in a lossy medium such as biological tissue. To demonstrate this capability, a numerical model incorporates a first layer that is 2 mm thick with ∈ᵣ₁=36.0, σ₁=4.0 S/m; the second layer is 12 mm thick with ∈ᵣ₁=9.0, σ₂=0.4 S/m; and the third layer is 56 mm thick. The dielectric properties of the third layer are changed so that the relative permittivity and conductivity are progressively decreased in order to decrease the energy of the third reflection. The strength of the third reflection is described using the Y₃Y energy ratio, which is calculated as the ratio between the energies in the third reflection, y₃(nTₛ), and the reflection data, y(nTₛ). Here, y₃(nTₛ) is extracted from the reflection data using the procedure described previously.

A reference signal generated from a dielectric slab with the same properties as layer 1 may be used by the algorithm for these examples. The reflection data are decomposed into M=6 components by estimating the TOA and scaling factor of the reflection that arises from each interface. The slab is illuminated with an UWB differentiated Gaussian pulse having a −3 dB bandwidth of 4.37 GHz (1.14-5.51 GHz). The maximum frequency fₘₐₓ of the pulse is 7.7 GHz. The weak reflection test consists of two parts: examining the limits of detection and the robustness to noise.

First, the energy of the third reflection is progressively decreased by changing the layer 3 dielectric properties; the reflection data are not contaminated with noise samples. The effect that a decrease in energy of the third reflection has on the precision of the parameters estimates is shown in Table II. As expected, the third reflection's strength has no apparent effect on the quality of the parameter estimates associated with the first two reflections. However, a Y₃Y energy ratio below −32 dB leads to a deterioration in the TOA of the third reflection and a Y₃Y energy ratio below −34 dB leads to a deterioration in the estimation quality of the third reflection's amplitude.

TABLE II
Effect that a decrease in energy of the 3rd reflection
has on the precision of the parameters estimates.

| Layer 3 | Y₃Y | Δwₑ(1) | Δwₑ(2) | αₑ(1) | αₑ(2) | αₑ(3) |
|---|---|---|---|---|---|---|
| Properties | (dB) | (mm) (%) | (mm) (%) | (%) | (%) | (%) |
| εᵣ = 40 | −24.1 | 0.21 | 0.11 | 0.0 | −0.3 | −19.2 |
| εᵣ = 27.3 | −25.7 | 0.21 | 0.21 | 0.0 | −0.4 | −22.0 |
| εᵣ = 15.2 | −29.7 | 0.21 | 0.85 | 0.0 | −1.8 | −33.5 |
| εᵣ = 12.0 | −32.2 | 0.24 | 1.27 | 0.0 | −1.4 | −34.1 |
| εᵣ = 10 | −34.4 | 0.19 | 1.91 | 0.0 | −1.2 | −59.1 |

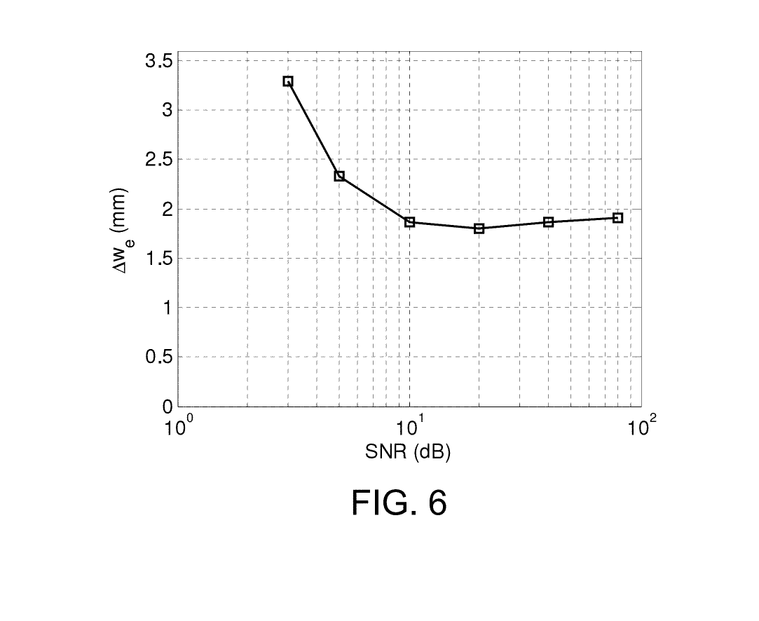

In another example, the dielectric properties of the third layer may be fixed to ∈ᵣ₃=10.0, σ₃=1.05 S/m to simulate a low contrast interface scenario and the reflection data contaminated with noise samples from the white Gaussian noise model to progressively lower the SNR. The error in the estimated thickness of the third layer at a signal-to-noise ratio (SNR) of 10 dB, the Y₃Y energy ratio is about −35 dB versus the SNR is shown in FIG. 6. The graph suggests that the estimated TOA of the third reflection is robust to the presence of noise at levels 10 dB and above, but starting at 5 dB, a significant deterioration in the quality of these estimates occurs.

In a practical scenario there is uncertainty in the number of interfaces that an object contains which typically means that the model order in (2) is not known a priori. Due to the damped nature of the reflected signals, information theoretic techniques, and Bayesian MMSE estimators may be unsuccessful in estimating this parameter. In an embodiment, model order mismatch may affect the accuracy of the estimates however the precise estimation of the model order is not required. The algorithm is generally robust to large deviations from the correct model order; but overestimation of the model order typically leads to more precise model parameter estimates than underestimation of the model order.

Application of Algorithm to 3D Data

Numerical Data

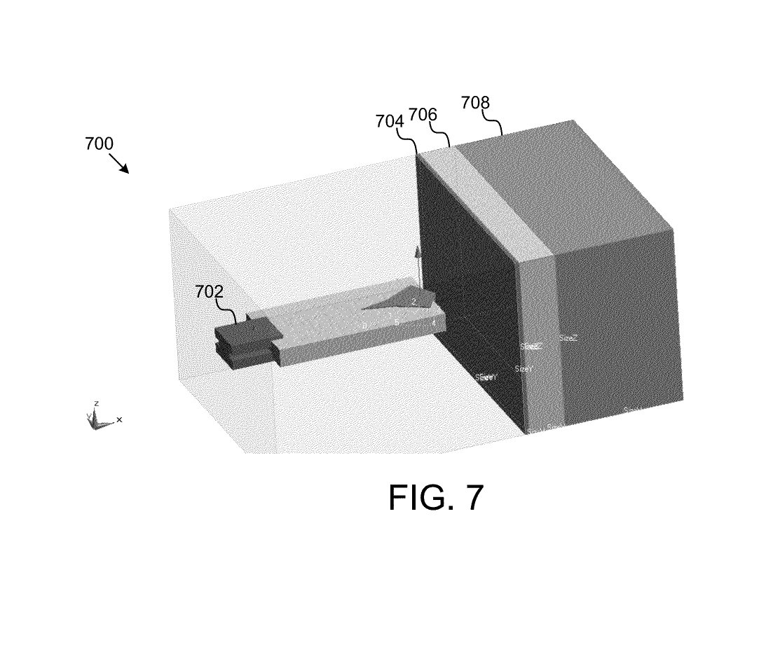

This example shows the performance of the algorithm when applied to numerical Data generated with a 3D slab using a realistic source/sensor model. The simulations may be carried out with a simulation tool such as SEMCAD X (SPEAG AG, Switzerland). A stratified and non-dispersive dielectric slab is placed within the simulation space as shown in FIG. 7. The thin outer layer 704 closest to the source/sensor 702 is 2 mm thick with ∈ᵣ₁=36, σ₁=4, the middle layer 706 is 18 mm thick with ∈ᵣ₂=9, σ₂=0.4 S/m, and the third layer 708 extends to infinity (i.e., is terminated with a PML) with ∈ᵣ₃=30, σ₃=3.0 S/m. Both the slab and source/sensor 702 are located in an immersion liquid with ∈ᵣ=2.5, σ=0.04 S/m. A Balanced Antipodal Vivaldi antenna with director (BAVA-D) may be placed 25 mm from the slab and illuminate the slab and record the resulting backscattered fields. The illuminating UWB pulse has a −3 dB bandwidth of 3.5 GHz (1/B≈0.286 ns) and a maximum frequency fₘₐₓ of 7.7 GHz. To evaluate if the algorithm is robust to the presence of noise in the data, noise samples from a colored noise process obtained by filtering a Gaussian process are added to the reflected data such that the SNR is 20 dB. The number of samples is N=2211 and the sample time is Tₛ=1.81 ps. A model order of M=4 is assumed.

FIG. 8 shows an example of the reference signal used for these examples and data contaminated with colored noise samples. The reflections from each interface used to evaluate the performance are extracted using the procedure described previously. These reflections are shown in FIG. 8(b) where significant overlap between the first two reflections (BΔT=0.28) and a weak third reflection (Y₃Y=−24.7 dB) may be observed relative to the other reflections. The estimated reflections corresponding to the three interfaces for this example are shown in FIG. 5(c). The thickness error for each layer is shown in Table III, demonstrating that the sub-mm accuracy noted in the 2D case is also achieved in 3D. The 3D results related to layer 1 are in agreement with the 2D case where BΔT=0.29 as shown in Table I; and the 3D results related to layer 2 are in agreement with the 2D case where Y₃Y=−25.7 dB as shown in Table II.

Overall, this example demonstrates performance features critical to near-field applications, namely the ability to accurately estimate parameters associated with two severely overlapping reflections contaminated with noise as well as the capability to accurately estimate the parameters associated with a weak reflection. Moreover, these results support the 2D findings, suggesting that the near-field 2D performance tests can be extended to an equivalent near-field 3D scenario that uses a realistic sensor model. The results also demonstrate that the algorithm's performance is not adversely affected by colored noise with an SNR of 20 dB. In one embodiment, these numerical results are comparable to those presented in literature.

For the example related to FIG. 8(b), it may be observed that a discrepancy exists between the waveform shapes of the first and second reflections: there are greater similarities between the reference signal and the first and third reflections than the reference signal and the second reflection. This leads to a violation of the signal model assumptions given by (1) due to lack of conformity between the reference and second reflection. This, in turn, leads to the presence of artifacts in the residue after the estimate of the first and second reflections are removed from Y to compute Y₃ in step 3.1 of the RDD algorithm. The results suggest that the effect that this phenomenon has on the TOA estimate is marginal. However, this phenomenon is important if the criterion is to accurately estimate the first two reflections.

Application of Algorithm to Experimental Data.

The performance of the method is tested further by applying it to experimental data collected using a setup similar to the one shown in FIG. 7. The setup consists of a tank containing an immersion liquid, a sensor (BAVA-D antenna) and layered objects or slabs. Canola oil may be used as the immersion liquid with ∈ᵣ=2.5, τ≈0.04. The reference signal may be acquired by inserting a metal plate in the tank at 35 mm from the antenna.

Measurements may be obtained with the antenna placed 25 mm in front of the slabs. For all cases, measurement data may be collected at 1601 points over the frequency range from 50 MHz to 15 GHz using a Vector Network Analyzer (VNA) (8722ES, Agilent Technologies, Palo Alto, Calif.). The VNA IF bandwidth is set to 1000 Hz and averaging is turned on and set to 3 sweeps per measurement. The frequency domain VNA measurements are weighted with a differentiated Gaussian signal with a −3 dB bandwidth of 3.11 GHz (1/B≈0.322 ns≈160ΔT), then transformed to time-domain data with an inverse chirp-z transform. The resulting time-domain signal has N=1751 samples and the sample time is Tₛ=2.00 ps.

TABLE III
The thickness error for each layer of the 3D numerical slab. The first layer
is 2 mm and the 2nd layer is 18 mm which corresponds to a reflection
overlap of BΔt = 0.28 and 1.27, respectively.

| Δwₑ(1) | Δwₑ(2) | | | |
|---|---|---|---|---|
| (mm) | (mm) | αₑ(1) | αₑ(2) | αₑ(3) |
| (%) | (%) | (%) | (%) | (%) |
| 0.08 | −0.73 | −5.3 | 1.6 | 0.3 |
| (4.0%) | (−4.0%) | | | |

For the first test, a two layer slab is formed by placing a 1.7 mm thick skin layer with ∈ᵣ₁=34.3 and σ₁=4.25 S/m (averaged over 1.0 to 10 GHz) over a 9.8 mm thick dielectric slab with ∈ᵣ₂=12.0, τ₂≈0.05-0.2 S/m (Eccostock HiK, Emerson and Cuming Microwave Products Randolph, Mass., USA). The skin layer may be constructed of silicone with dielectric fillers (LDF-32, Emerson and Cuming Microwave Products Randolph, Mass., USA) having dispersive properties.

The reflection data that the parameter estimation algorithm operates on and the reference signal used by the algorithm are shown in FIG. 9(a). The reflection data are decomposed into M=6 components, estimated reflections associated with each interface are shown in FIG. 9(b) and the corresponding layer thickness evaluations are shown in Table IV.

TABLE IV
thickness error for each layer of a 2 layer slab consisting of a very thin
skin layer over a dielectric slab.

| | | | | thickness error | |
|---|---|---|---|---|---|
| Layer | Properties | Actual | BΔT | (mm)/relative | |
| 1 | εᵣ = 34.3 | 1.7 | 0.21 | +0.60 | (38.5%) |
| 2 | εᵣ = 12.0 | 9.8 | 0.70 | −0.28 | (−2.86%) |

Very accurate estimation of the second 9.8 mm slab layer is achieved regardless of the overlap between the second and third reflections implied by the BΔT product. This overlap between the estimated reflections is shown in FIG. 9(b). These results support the validity of applying the algorithm to the near-field application of estimating reflections from closely spaced interfaces, where the spacing is close relative to the wavelength of interest.

The same test apparatus, excitation signal, and reference signal may be used for a second test in which the slab consists of three layers formed by sandwiching a 13.0 mm dielectric slab with ∈ᵣ₂=6.0, σ₂≈0.05-0.2 S/m between a two 9.8 mm thick dielectric slabs with properties of ∈ᵣ₁=12.0, σ₁≈0.05-0.2 S/m and ∈ᵣ₃=10.0, σ₃≈0.05-0.2 S/m, respectively. The slabs are Eccostock HiK (Emerson and Cuming Microwave Products).

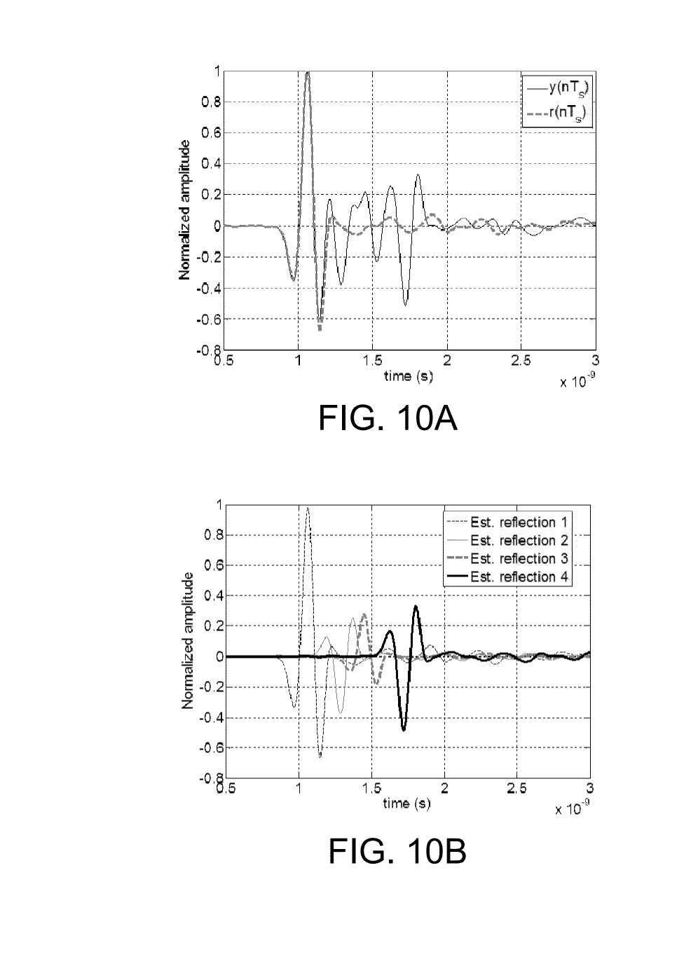

The reflection data and the reference signal used by the algorithm are shown in FIG. 10(a). The reflection data are decomposed into M=6 components and the four estimated reflections that arise from the four interfaces are shown in FIG. 10(b). The TOA of the estimated reflections used to evaluate the layer thicknesses are shown in Table V. Although each layer is thinner than the resolution limit of a matched filter, the layer thicknesses are estimated with sub-mm accuracy. As with the 2D and 3D simulated cases, the very precise estimation of each slab's thickness is achieved regardless of the overlap of the reflections. Importantly, this general example demonstrates the algorithm's ability to accurately estimate the parameters of multiple reflections associated with several closely spaced interfaces.

For the dispersive skin layer, sub-mm precision of the skin's estimated thickness is achieved regardless of the extreme overlap between the 1^{st} and 2^{nd} reflections which is implied by the BΔT value. This result is in close agreement with a similar case examined for the 2D resolving two signals test where BΔT=0.21 (Table I). This suggests that thin layers of dispersive materials may not lead to deterioration of the algorithm's performance since preservation of the waveform shape is expected over regions that are sub-wavelengths in extent. In an embodiment, scenarios where the material is both dispersive and has a large extent relative to the wavelength of the incident pulse may adversely affect the performance of the algorithm. For these situations, the reference signal r(nTs) may take into account the dispersive effects of the medium.

Since the reflection from a metal plate is used to construct the reference signal, the result also supports the conclusion drawn for the 2D case that the algorithm is robust to discrepancies between the material properties with which the reference signal is acquired and the dielectric properties of the interface from which a target reflection arises. The results also demonstrate that waveform shape conformity between the reference and reflections is robust in an experimental setting.

Finally, all numerical and experimental data sets are generated with planar slabs that have abrupt and ‘smooth’ boundaries (i.e., no spatial variations of the boundary relative to the wavelength of the illuminating signal) so the effects that arise due to the multipath phenomena are minimized. This phenomenon may be observed for scenarios where the boundaries are curved and irregularly shaped. The signal model given by (1) assumes that each reflection corresponds to a single scattering event from a medium interface so the multipath phenomena violate this assumption. One approach to resolving the multipath problem is to use multiple antennas to provide multiple views of the boundaries.

TABLE V
thickness errors of 3 layer slab used to evaluate algorithm's performance
when applied to experimental data. TOA from 4 reflections are required to
estimate thickness of the 3 layers.

| | | | | thickness error |
|---|---|---|---|---|
| Layer | Properties | Actual | BΔT | (mm)/relative (%) |
| 1 | εᵣ = 12.0 | 9.8 | 0.70 | −0.11 (−1.09%) |
| 2 | εᵣ = 6.0 | 9.8 | 0.50 | +0.11 (−1.16%) |
| 3 | εᵣ = 10.0 | 13.0 | 0.85 | −0.11 (−0.82%) |

Although embodiments of the present invention have been described with relation to near-field electromagnetic reflections, one of ordinary skill will recognize that these embodiments may be equally applied to other reflective technologies, such as acoustic systems which incorporate ultrasonic transducer devices, and the like.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method comprising:
identifying data associated with a reference signal in a reflection-based imaging device;
identifying shifted and scaled versions of the reference signal in reflection data gathered by the reflection-based imaging device; and
solving a time-of-arrival and a scaling factor of the reference signal with a non-linear optimization.

2. The method of claim 1, wherein identifying the time-of-arrival and scaling factor of each modeled reflection comprises:
identifying the time-of-arrival of the first reflection from the spectral component corresponding to the dominant peak of the spectrum of the convolution of the reference signal and the reflection data;
determining an interval of values containing the scaling factor using the time-of-arrival; and
identifying the scaling factor within the interval.

3. The method of claim 2, further comprising:
removing data associated with the first reflection;
identifying the time-of-arrival of the second reflection from the spectral component corresponding to the dominant peak of the spectrum of the convolution of the reference signal and the reflection data that has data associated with the first reflection removed;
determining an interval of values containing the scaling factor using the time-of-arrival; and
identifying the scaling factor within the interval.

4. The method of claim 3, further comprising:
removing data associated with the second reflection from the reflection data; and
refining accuracy of the time-of-arrival and scaling factor associated with first reflection using reflection data that has data associated with the second reflection removed.

5. The method of claim 4, further comprising removing data associated with the first reflection from the reflection data and refining the accuracy of the time-of-arrival and scaling factor associated with the second reflection using reflection data that has data associated with the first reflection removed.

6. The method of claim 5, further comprising iteratively refining the accuracy of the time-of-arrival and scaling factor associated with each reflection in order to improve the accuracy of the estimate of each reflection for improved temporal resolution.

7. The method of claim 6, further comprising independently solving the time-of-arrival and the scaling factor for each of a plurality of reflections and independently refining the time-of-arrival and the scaling factor for each of the plurality of reflections iteratively, wherein independently solving and independently refining comprises removing reflection data associated with previously modeled reflections.

8. The method of claim 6, further comprising independently solving the time-of-arrival and the scaling factor for the Mth reflection by removing reflection data associated with the other M−1 modeled reflections.

9. The method of claim 8, further comprising iteratively refining the time-of-arrival and the scaling factor for each of the M modeled reflections by removing reflection data associated with all other modeled reflections.

10. A tangible non-transitory computer-readable medium comprising executable code that, when executed by a processing device, causes the processing device to perform operations comprising:
identifying data associated with a reference signal in a reflection-based imaging device;
identifying shifted and scaled versions of the reference signal in reflection data gathered by the reflection-based imaging device; and
solving a time-of-arrival and a scaling factor of the reference signal with a non-linear optimization.

11. The computer-readable medium of claim 10, wherein identifying the time-of-arrival and scaling factor of each modeled reflection comprises:
identifying the time-of-arrival of the first reflection from the spectral component corresponding to the dominant peak of the spectrum of the convolution of the reference signal and the reflection data;
determining an interval of values containing the scaling factor using the time-of-arrival; and
identifying the scaling factor within the interval.

12. The computer-readable medium of claim 11, wherein the operations further comprise:
removing data associated with the first reflection;
identifying the time-of-arrival of the second reflection from the spectral component corresponding to the dominant peak of the spectrum of the convolution of the reference signal and the reflection data that has data associated with the first reflection removed;
determining an interval of values containing the scaling factor using the time-of-arrival; and
identifying the scaling factor within the interval.

13. The computer-readable medium of claim 12, wherein the operations further comprise:
removing data associated with the second reflection from the reflection data; and
refining accuracy of the time-of-arrival and scaling factor associated with first reflection using reflection data that has data associated with the second reflection removed.

14. The computer-readable medium of claim 13, wherein the operations further comprise removing data associated with the first reflection from the reflection data and refining the accuracy of the time-of-arrival and scaling factor associated with the second reflection using reflection data that has data associated with the first reflection removed.

15. The computer-readable medium of claim 14, wherein the operations further comprise iteratively refining the accuracy of the time-of-arrival and scaling factor associated with each reflection in order to improve the accuracy of the estimate of each reflection for improved temporal resolution.

16. The computer-readable medium of claim 15, wherein the operations further comprise independently solving the time-of-arrival and the scaling factor for each of a plurality of reflections and independently refining the time-of-arrival and the scaling factor for each of the plurality of reflections iteratively, wherein independently solving and independently refining comprises removing reflection data associated with previously modeled reflections.

17. The computer-readable medium of claim 15, wherein the operations further comprise independently solving the time-of-arrival and the scaling factor for the Mth reflection by removing reflection data associated with the other M−1 modeled reflections.

18. The computer-readable medium of claim 17, wherein the operations further comprise iteratively refining the time-of-arrival and the scaling factor for each of the M modeled reflections by removing reflection data associated with all other modeled reflections.

19. A system, comprising:
an imaging signal source configured to generate a signal to be directed to a reference object and a test object;
a reflection detector configured to receive one or more reflections of the signal from the reference object and the test object; and
a data processor coupled to the reflection detector and configured to:
identify data associated with a reference signal in a reflection-based imaging device;
identify shifted and scaled versions of the reference signal in reflection data gathered by the reflection-based imaging device; and
solve a time-of-arrival and a scaling factor of the reference signal with a non-linear optimization.

20. The system of claim 19, wherein the data processor is further configured to:
identify the time-of-arrival of the first reflection from the spectral component corresponding to the dominant peak of the spectrum of the convolution of the reference signal and the reflection data;
determine an interval of values containing the scaling factor using the time-of-arrival; and
identify the scaling factor within the interval.

21. The system of claim 20, wherein the data processor is further configured to:
remove data associated with the first reflection;
identify the time-of-arrival of the second reflection from the spectral component corresponding to the dominant peak of the spectrum of the convolution of the reference signal and the reflection data that has data associated with the first reflection removed;
determine an interval of values containing the scaling factor using the time-of-arrival; and
identify the scaling factor within the interval.

22. The system of claim 21, wherein the data processor is further configured to:
removing data associated with the second reflection from the reflection data; and
refine accuracy of the time-of-arrival and scaling factor associated with first reflection using reflection data that has data associated with the second reflection removed.

23. The system of claim 22, wherein the data processor is further configured to remove data associated with the first reflection from the reflection data and refining the accuracy of the time-of-arrival and scaling factor associated with the second reflection using reflection data that has data associated with the first reflection removed.

24. The system of claim 23, wherein the data processor is further configured to iteratively refine the accuracy of the time-of-arrival and scaling factor associated with each reflection in order to improve the accuracy of the estimate of each reflection for improved temporal resolution.

25. The system of claim 24, wherein the data processor is further configured to independently solving the time-of-arrival and the scaling factor for each of a plurality of reflections and independently refine the time-of-arrival and the scaling factor for each of the plurality of reflections iteratively, wherein independently solving and independently refining comprises removing reflection data associated with previously modeled reflections.

26. The system of claim 24, wherein the data processor is further configured to independently solve the time-of-arrival and the scaling factor for the Mth reflection by removing reflection data associated with the other M−1 modeled reflections.

27. The system of claim 26, wherein the data processor is further configured to iteratively refine the time-of-arrival and the scaling factor for each of the M modeled reflections by removing reflection data associated with all other modeled reflections.
